(19) United States
(12) Patent Application Publication
(10) Pub. No.: US 2023/0066134 A1
(43) Pub. Date: Mar. 2, 2023

(54) INSULATING GLASS PANE ARRANGEMENT WITH INTEGRATED COMPONENT

(71) Applicant: SAINT-GOBAIN GLASS FRANCE, COURBEVOIE (FR)

(72) Inventors: Christian EFFERTZ, AACHEN (DE); Shelby Doane CRAIG, HERZOGENRATH (DE); Varun RAMESH KUMAR, AACHEN (DE)

(21) Appl. No.: 17/799,583

(22) PCT Filed: Jan. 21, 2021
(86) PCT No.: PCT/EP2021/051316

§ 371 Date: Aug. 12, 2022

(30) Foreign Application Priority Data
Feb. 14, 2020 (EP) 20157286.4

(51) Int. Cl. E06B 3/663; G06K 19/06; G06K 7/10; G06K 7/12

(52) U.S. Cl. CPC E06B 3/66366; G06K 19/0614; G06K 7/10158; G06K 7/12; E06B 2009/2476

(57) ABSTRACT

An insulating glass pane arrangement includes at least one first pane having a first surface and a second surface, wherein the first pane is designed as an inner pane, at least one second pane having a first surface and a second surface, wherein the second pane is designed as an outer pane, at least one first cavity that is arranged between the first pane and the second pane, at least one component arranged in the first cavity including a data memory, a read-out device with an active transmitting device, and an energy harvesting element, wherein the read-out device and the energy harvesting element are designed for read-out and energy harvesting through the first pane.

The invention relates to an insulating glass pane arrangement with an integrated component.

An alarm pane arrangement, for example, is known from the prior art. An alarm pane arrangement with a first pane and a second pane spaced apart by means of a spacer is known from WO 2017/085303 A1. A sensor unit with an inductive sensor which faces a transparent electrically conductive coating of the first pane is arranged in a cavity between the panes. The sensor unit can include a solar cell and an accumulator as well as a transmission unit.

Further known, from WO 2015/154688 A1, is an alarm pane arrangement with a humidity sensor and a motion sensor. The alarm unit is arranged on a spacer of an insulating glass pane arrangement and can include a solar cell with which a battery of the alarm unit is charged. The use of batteries has the disadvantage that they have a very limited service life.

Known from EP 3 396 339 A1 and US 2011/133940 A1 are insulating glazings with integrated sensors that can be supplied with energy via solar cells and whose sensors can be read out from outside the insulating glazing via a transmission unit.

Also known are insulating glazing units with integrated RFID chips for identification of the insulating glazing unit, for example, from WO 2019/219461 A1.

Furthermore, it is known to couple sensors to so-called RFID chips, with a UHF sensor and receiver required for reading out the RHID chips. In particular, when using an NFC chip as an RFID chip, it is necessary to apply it flat on the pane. Such a flat application of the chip is undesirable for a large number of applications. When such a chip is applied on the surface, it is exposed to environmental influences or to possible unwanted removal by an unauthorized person. However, when such a chip is arranged in the interior of an insulating glass pane arrangement, a signal is attenuated by metallic spacers or metallic or conductive coatings.

The object of the invention is to specify an insulating glass pane arrangement having a readable component that can be read out easily and has little effect on a field of vision of the panes.

This object is accomplished by the features of claim 1. Useful embodiments result from the dependent claims.

The insulating glass pane arrangement according to the invention comprises
at least one first pane having a first surface and a second surface, wherein the first pane is designed as an inner pane,
at least one second pane having a first surface and a second surface, wherein the second pane is designed as an outer pane,
at least one first cavity arranged between the first pane and the second pane,
at least one component arranged in the first cavity comprising a data memory, a read-out device with an active transmitting device, and an energy harvesting element, wherein the read-out device and energy harvesting element are designed for read-out and energy harvesting through the first pane.

The first and the second pane are, in particular, glass panes. A pane “designed as an inner pane” means the pane which, in an installed state, e.g., in a building or vehicle, is oriented toward the interior. A pane “designed as an outer pane” means the pane which, in an installed state, e.g., in a building or vehicle, is oriented away from the interior and is thus exposed to solar radiation, rain, or other environmental influences.

In particular, the second pane can be a pane provided with a coating, e.g., metallic coating, tinting, and/or film, for example, to increase the break resistance of the pane, to reflect heat, or solar protection coatings. Such panes are known, for example, from WO 2019/110172 A1. The first and the second pane are arranged spaced apart from one another such that a first cavity is created between the panes. For this purpose, spacers are arranged perimetrally, in particular between a second surface of the first pane and a first surface of the second pane. In one embodiment, the second pane is provided with a coating that reduces transmission of light and/or radio waves.

A component is arranged in the first cavity. The component can, for example, be arranged on a surface of the spacer. The spacer is expediently made of metal and/or plastic. The energy harvesting element is oriented such that energy harvesting is done through the first pane. Furthermore, the active transmitting device is arranged such that a signal with data is transmitted wirelessly through the first pane.

The energy harvesting element is suitable for generating the electrical energy required for the operation of the active transmitter, in particular, so-called energy harvesting. In principle, this can, in particular, be piezoelectric, thermoelectric, or photoelectric energy harvesting, or by coupling of electromagnetic radiation. Expediently, the energy harvesting element is a solar cell, in particular a solar cell tuned to a spectrum of artificial light, in particular, a solar cell tuned to a spectrum of an LED lamp. A conventional solar cell made of crystalline or amorphous silicon can be used as the solar cell; however, other organic or inorganic solar cells can be used. The solar cell is, in particular, arranged such that it can be illuminated by a user by means of a light or lamp, in particular a flashlight, in particular a lamp of the reading device, e.g., a smartphone or tablet. Thus, the user can read the component out from the interior with the insulating glass pane arrangement in the installed state. When the energy harvesting element is a solar cell, sunlight can additionally also be used for the operation of the component and the transmitter can transmit. Such an arrangement has the advantage that it is independent of sunlight. The component can thus, for example, even be read at night. Furthermore, the component can even be read when the insulating glass pane arrangement is situated in a warehouse, for example, before installation or after removal.

In an advantageous embodiment of an insulating glass pane arrangement according to the invention, the energy harvesting element and, in particular, the solar cell tuned to the spectrum of an LED light is oriented such that the energy harvesting element and, in particular, the solar cell can be illuminated and supplied with energy through the first pane using the LED lamp of a reading device, preferably of a mobile phone, smartphone or tablet.

In another advantageous embodiment of an insulating glass pane arrangement according to the invention, the energy harvesting element and, in particular, the solar cell tuned to the spectrum of an LED lamp, is attached to the first pane such that the energy harvesting element can be illuminated and supplied with energy from the interior by the LED lamp of a reading device, preferably of a mobile phone, smartphone, or tablet in the installed state of the insulating glazing arrangement.

In one embodiment, the active transmitting device comprises a radio transmitting unit, preferably for Bluetooth and/or WLAN, or an infrared transmitter. Expediently, the transmitting device is a transmitting device for short distances with low energy consumption. Furthermore, the component can have a receiving unit for receiving a signal with data.

In another embodiment, the insulating glass pane arrangement includes a third pane having a first surface and a second surface, with the third pane arranged between the first and the second pane, with the first cavity arranged between the first pane and the third pane. In such an insulating glass pane arrangement, the first cavity is arranged between the pane designed as an inner pane and the middle pane, and a second cavity is arranged between the pane designed as an outer pane and the middle pane. In an embodiment having more panes, the first cavity is still the cavity adjacent the second surface of the first pane such that the component can be read from the interior in an installed state.

Expediently, the component includes a sensor, the sensor being, in particular, a temperature sensor and/or a pressure sensor and/or a humidity sensor.

In another embodiment, the memory includes a permanent and/or overwritable memory. Such a memory can, for example, temporarily or permanently store data concerning storage, installation, structure of the insulating glass pane arrangement, manufacturer data, usage parameters, and/or sensor data. In an embodiment, the component can be designed to store data received with the receiver in the memory.

Furthermore, the component can optionally include a capacitor, in particular a supercapacitor, which can enable operation of the component beyond the actual energy transfer to the energy harvesting element.

The invention further relates to a system consisting of an insulating glass pane arrangement according to the invention and a reading device, wherein the reading device is suitable for transferring energy to the energy harvesting element.

The reading device expediently includes a lamp or light source, in particular an LED lamp, with the reading device being in particular a mobile phone, smartphone, or tablet. Such a lamp is expediently switchable and/or controllable. With the help of a computer program product, such a reading device is suitable for switching on the lamp of the reading device and starting data reception. Expediently, the data received can be displayed on a display of the reading device and/or stored and/or further processed. After completion of the data reception, the lamp of the reading device is switched off.

The computer program product according to the invention controls the energy transfer from the reading device to the energy harvesting element and to the readout of the data memory. In particular, the energy transfer is first started; optionally, the orientation or strength of the energy transfer is adjusted and/or the user is prompted for optimal positioning of the reading device; the data transmission is then started; and after completion of the data transmission, the energy transfer is terminated.

In the following, the invention is also explained in detail with respect to other features and advantages using the description of exemplary embodiments and referring to the accompanying drawings. They depict, in a schematic drawing in each case:

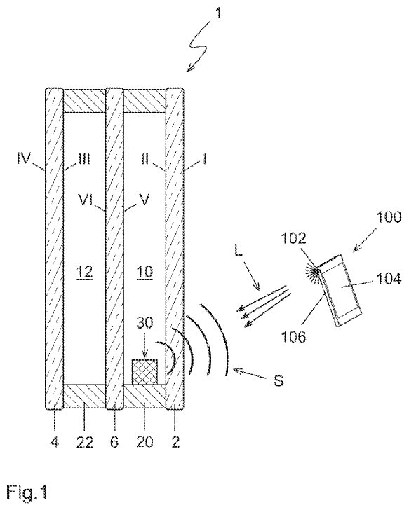

FIG. 1 System consisting of insulating glass pane arrangement and reading device,

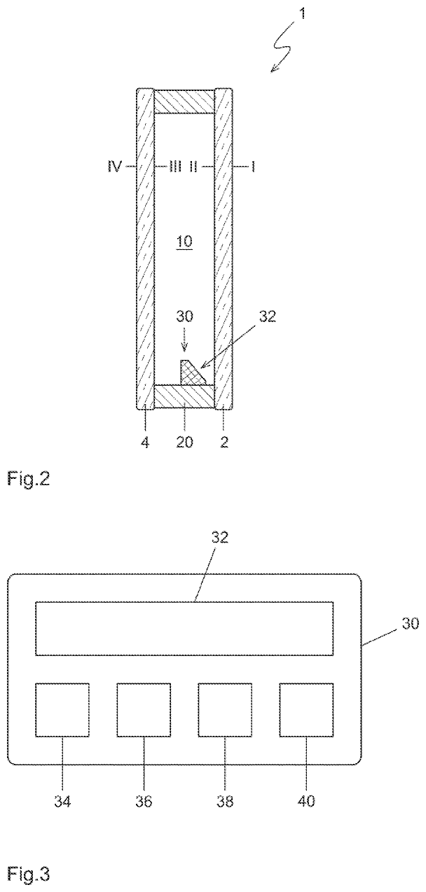

FIG. 2 Embodiment of an insulating glass pane arrangement, and

FIG. 3 Schematic structure of the component.

FIG. 1 depicts a first embodiment of a system consisting of an insulating glass pane arrangement 1 with a reading device 100. The insulating glass pane arrangement 1 comprises a first pane 2, a second pane 4, and a third pane 6. The first pane 2 has a first surface I and a second surface H; the second pane 4, a first surface III and a second surface IV; and the third pane 6, a first surface V and a second surface VI. Here, the second pane 4 is designed as an outer pane, in other words, the second surface IV of the second pane 4 is directed, in the installed state, toward the exterior of a building or vehicle. The first pane 2 is designed as an inner pane, in other words, the first surface I of the first pane 2 is, in the installed state, directed toward the inside of a building or vehicle.

The first pane 2 and the third pane 6 are spaced apart from one another by a spacer 20. The second surface II of the first 2 and the first surface V of the third pane 6 form, together with the spacer 20, boundaries of first cavity 10. The third pane 6 and the second pane 4 are again spaced apart with a spacer 22 and form a second cavity 12.

A component 30 is arranged in the first cavity 10, in particular on the spacer 20. The component 30 is thus arranged on the cavity oriented toward the inside. The component 30 comprises, as shown in FIG. 3, an energy harvesting element 32, a read-out device 34, a data memory 36, and, optionally, a sensor 38 or capacitor (40). Here, both the energy harvesting element 32 and the read-out device 34 are respectively designed such that they receive energy, in particular in the form of light radiation, through the first pane 2 and also transmit data, e.g., by radio, through the first pane 2. The energy harvesting element 32 is preferably a solar cell, which, when illuminated by an artificial light source or lamp, produces sufficient electricity to enable a transmitter of the read-out device 34 to transmit a signal with data. For this purpose, the read-out device 34 includes, in particular, a transmitter for transmitting a high-frequency radio signal, e.g., via Bluetooth.

The optional sensor can, in particular, be a temperature sensor and/or a pressure sensor and/or a humidity sensor.

FIG. 1 further depicts a reading device. The reading device comprises a device for transferring energy, in particular, a lamp 102, a display device, in particular, a display 104, and a receiver 106 for receiving a signal with data. The receiver is, in particular, a radio receiver, e.g., for a Bluetooth signal. The reading device can be, for example, a tablet or a smartphone with a computer program product, in particular, an app that controls the energy transfer from the reading device to the energy harvesting element and for reading out the data memory. In particular, first, the energy transfer is started; optionally, the orientation of the energy transfer is adjusted and/or the user is prompted for the optimal positioning of the reading device; after that, the data transmission is started; and after completion of the data transmission, the energy transfer is terminated.

FIG. 2 depicts another embodiment of an insulating glass pane arrangement 1. This differs from the insulating glass pane arrangement 1 shown in FIG. 1 in that it comprises exclusively a first and a second pane 2, 4. The first pane 2 and the second pane 4 have, respectively, a first surface I, III and a second surface IV. The first pane 2 and the second pane 4 are spaced apart from one another by means of a spacer 20 such that a first cavity 10 is formed between the second surface II of the first pane 2 and the first surface IV of the second pane 4 The component 30, which has, on the second surface II of the first pane 2, an energy harvesting element 32 in the form of a solar cell, is arranged in the first cavity 10. The solar cell is oriented such that a user standing at the first surface I of the first pane 2 can point the lamp 102 of his reading device at the solar cell in order to then receive data from the component 30 by means of radio transmission.

### LIST OF REFERENCE CHARACTERS

1 insulating glass pane arrangement
2 first pane
4 second pane
6 third pane
10 first cavity
12 second cavity
20 spacer
22 spacer
30 component
32 energy harvesting element
34 read-out device
36 data memory
38 sensor
40 capacitor
100 reading device
102 lamp
104 display
106 receiver
I, III, V first surface
II, IV, VI second surface
L light
S data transmission

1. An insulating glass pane arrangement, comprising:
at least one first pane having a first surface and a second surface, wherein the at least one first pane is designed as an inner pane,
at least one second pane having a first surface and a second surface, wherein the at least one second pane is designed as an outer pane,
at least one first cavity that is arranged between the at least one first pane and the at least one second pane,
at least one component arranged in the at least one first cavity comprising a data memory, a read-out device with an active transmitting device, and an energy harvesting element, wherein the read-out device and energy harvesting element are designed adapted for read-out and energy harvesting through the at least one first pane and the energy harvesting element is a solar cell tuned to a spectrum of an LED lamp.

2. The insulating glass pane arrangement according to claim 1,
wherein the energy harvesting element can is adapted to be illuminated and supplied with energy using the LED lamp of a reading device.

3. The insulating glass pane arrangement according to claim 1,
wherein the active transmitting device includes a radio transmitting unit
or an infrared transmitter and optionally includes a receiving unit.

4. The insulating glass pane arrangement according to claim 1, comprising a third pane having a first surface and a second surface, wherein the third pane is arranged between the at least one first pane and the at least one second pane, wherein the first cavity is arranged between the at least one first pane and the third pane.

5. The insulating glass pane arrangement according to claim 1, wherein the at least one component comprises a sensor, wherein the sensor is in particular a temperature sensor and/or a pressure sensor and/or a humidity sensor.

6. The insulating glass pane arrangement according to claim 1, wherein the data memory comprises a permanent and/or overwritable data memory.

7. The insulating glass pane arrangement according to claim 1, wherein the at least one component further includes a capacitor, in particular a supercapacitor.

8. The insulating glass pane arrangement according to claim 1, wherein the at least one second pane has a coating that reduces the transmission of light or radio waves.

9. System A system consisting of an insulating glass pane arrangement according to claim 1 and a reading device, wherein the reading device is adapted to transfer suitable for transferring energy to the energy harvesting element.

10. The system according to claim 9, wherein the reading device includes a lamp, wherein the reading device is a mobile phone, smartphone, or tablet.

11. The insulating glass pane arrangement according to claim 2,
wherein the reading device is a mobile phone, smartphone, or tablet.

12. The insulating glass pane arrangement according to claim 3,
wherein the radio transmitting unit is a Bluetooth™ and/or WLAN radio transmitting unit.

13. The insulating glass pane arrangement according to claim 7, wherein the capacitor is a supercapacitor.

14. The system according to claim 10, wherein the lamp is an LED lamp.
